(19) United States
(12) Patent Application Publication
(10) Pub. No.: US 2026/0211287 A1
(43) Pub. Date: Jul. 23, 2026

(54) DISPLAY DEVICE

(71) Applicant: AUO Corporation, Hsinchu City (TW)

(72) Inventors: Shu-Wen Liao, Hsinchu City (TW); Wang-Shuo Kao, Hsinchu City (TW); Ti-Kuei Yu, Hsinchu City (TW)

(73) Assignee: AUO Corporation, Hsinchu City (TW)

(21) Appl. No.: 19/228,800

(22) Filed: Jun. 5, 2025

(30) Foreign Application Priority Data
Jan. 17, 2025 (TW) 114102081

(51) Int. Cl. G02F 1/1343

(52) U.S. Cl. CPC G02F 1/134309; G02F 1/13439; G02F 2202/28

(57) ABSTRACT

A display device has a first display area and a second display area, and includes a first substrate, a second substrate, a display medium layer, a light-emitting element, a transparent electrode layer, and a pixel electrode. The second substrate overlaps the first substrate. The display medium layer is located between the first substrate and the second substrate. The light-emitting element is located between the first substrate and the display medium layer in the first display area. The transparent electrode layer is located between the second substrate and the display medium layer in the first display area and includes multiple transparent electrode patterns arranged with spacing. The pixel electrode is located between the first substrate and the display medium layer or between the second substrate and the display medium layer in the second display area.

### CROSS-REFERENCE TO RELATED APPLICATION

This application claims the priority benefit of Taiwan application serial no. 114102081, filed on January 17, 2025. The entirety of the above-mentioned patent application is hereby incorporated by reference herein and made a part of this specification.

### BACKGROUND

### Technical Field

The disclosure relates to an optoelectronic device, and in particular to a display device.

### Related Art

Currently, displays with two-dimensional/three-dimensional (2D/3D) image switching capability all have an additional liquid crystal (LC) cell responsible for 2D/3D switching stacked on top of a liquid crystal panel displaying 2D screens, making the display device very thick and heavy. Additionally, for some screens that only require 2D display, being equipped with a full LC cell responsible for 2D/3D switching may cause a reduction in the resolution of the 2D display screen.

### SUMMARY

The disclosure provides a display device with reduced thickness and weight as well as improved a resolution of 2D display.

An embodiment of the disclosure proposes a display device having a first display area and a second display area, and including a first substrate, a second substrate, a display medium layer, a light-emitting element, a transparent electrode layer, and a pixel electrode. The second substrate overlaps the first substrate. The display medium layer is located between the first substrate and the second substrate. The light-emitting element is located in the first display area and between the first substrate and the display medium layer. The transparent electrode layer is located in the first display area and between the second substrate and the display medium layer, and includes multiple transparent electrode patterns arranged with spacing. The pixel electrode is located in the second display area and between the first substrate and the display medium layer or between the second substrate and the display medium layer.

In an embodiment of the disclosure, multiple first gaps exist between the transparent electrode patterns of the transparent electrode layer.

In an embodiment of the disclosure, an angle between an extending direction of the transparent electrode patterns and a long edge direction of the display device is between 30° and 60°.

In an embodiment of the disclosure, the pixel electrode has multiple second gaps.

In an embodiment of the disclosure, the display device further includes a planarization layer. The planarization layer is located in the first display area and covers the light-emitting element.

In an embodiment of the disclosure, the display device further includes a first transparent surface electrode. The first transparent surface electrode is located on the planarization layer and located on a side of the display medium layer opposite to the transparent electrode layer.

In an embodiment of the disclosure, the display device further includes a grating. The grating is located on the first transparent surface electrode and on the same side of the display medium layer as the light-emitting element.

In an embodiment of the disclosure, the display device further includes a second transparent surface electrode. The second transparent surface electrode is located in the second display area and located on a side of the display medium layer opposite to the pixel electrode.

In an embodiment of the disclosure, the display device further includes a first frame glue. The first frame glue is located at the edge of the display device.

In an embodiment of the disclosure, a number of light-emitting elements is multiple, and the display device further includes a second frame glue. The second frame glue covers the light-emitting element adjacent to the second display area among the light-emitting elements.

In an embodiment of the disclosure, the display medium layer includes a first type display medium molecule located in the first display area and a second type display medium molecule located in the second display area.

In an embodiment of the disclosure, a birefringence of the first type display medium molecule is greater than a birefringence of the second type display medium molecule.

In an embodiment of the disclosure, a voltage of the light-emitting element covered by the second frame glue is different from a voltage of the light-emitting element overlapping with the transparent electrode layer.

In an embodiment of the disclosure, the display device further includes a first transistor. The first transistor is located in the first display area and is electrically connected to the light-emitting element.

In an embodiment of the disclosure, the display device further includes a second transistor. The second transistor is located in the second display area and electrically connected to the pixel electrode.

An embodiment of the disclosure proposes a display device having a first display area and a second display area adjacent to each other, and includes a first display unit, a second display unit, a transparent electrode layer, and a first display medium layer. The first display unit is located in the first display area. The second display unit is located in the second display area. The transparent electrode layer is located above the first display unit, and includes multiple transparent electrode patterns arranged with spacing. The first display medium layer is located between the transparent electrode layer and the first display unit.

In an embodiment of the disclosure, the first display unit includes a self-illuminating element.

In an embodiment of the disclosure, the second display unit includes a second display medium layer, and a birefringence of the first type display medium molecule of the first display medium layer is greater than a birefringence of the second type display medium molecule of the second display medium layer.

In an embodiment of the disclosure, the angle between an extending direction of the transparent electrode patterns and a long edge direction of the display device is between 30° and 60°.

In an embodiment of the disclosure, the spacing between the transparent electrode patterns of the transparent electrode layer is 3 μm to 600 μm.

To make the aforementioned features and advantages of the disclosure comprehensible, embodiments are specifically provided below, with detailed descriptions in conjunction with the accompanying drawings.

### BRIEF DESCRIPTION OF THE DRAWINGS

FIG. 1A is a top schematic view of a display device according to an embodiment of the disclosure.

FIG. 1B to FIG. 1C are cross-sectional schematic views taken along section line A-A’ of FIG. 1A.

FIG. 2 is a cross-sectional schematic view of a display device according to an embodiment of the disclosure.

FIG. 3A is a top schematic view of a display device according to an embodiment of the disclosure.

FIG. 3B is a cross-sectional schematic view taken along section line A-A’ of FIG. 3A.

### DESCRIPTION OF THE EMBODIMENTS

In the drawings, for clarity, the thickness of layers, films, panels, and regions has been exaggerated. Throughout the specification, the same reference numerals denote the same elements. It should be understood that when an element such as a layer, a film, a region, or a substrate is referred to as being ‘‘on’’ or ‘‘connected’’ to another element, it may be directly on or connected to another element, or intervening elements may also be present. In contrast, when an element is referred to as being ‘‘directly on’’ or ‘‘directly connected to’’ another element, there are no intervening elements present. As used herein, ‘‘connection’’ may refer to a physical and/or electrical connection. In addition, an ‘‘electrical connection’’ or ‘‘coupling’’ may be another element between two elements.

It should be understood that, although the terms “first”, “second”, "third", etc. may be used herein to describe various elements, components, regions, layers and/or portions, these elements, components, regions, layers, and/or portions should not be limited by these terms. These terms are only used to distinguish one element, component, region, layer, or portion from another element, component, region, layer, or portion. Thus, a “first element”, “component”, “region”, “layer”, or “portion” discussed below could be termed a second element, component, region, layer, or portion without departing from the teachings herein.

The terminology used herein is for the purpose of describing particular embodiments only and is not intended to be limiting. As used herein, unless the context clearly indicates otherwise, the singular forms “a”, “an”, and “the” are intended to include the plural forms, including “at least one” or indicating “and/or.” As used herein, the term “and/or” includes any and all combinations of one or more of the associated listed items. It should also be understood that when used in this specification, the terms “comprise” and/or “include” specify the presence of stated features, regions, integers, steps, operations, elements, and/or components, but do not preclude the presence or addition of one or more other features, regions, integers, steps, operations, elements, components, and/or combinations thereof.

Furthermore, relative terms such as “below” or “bottom” and “above” or “top” may be used herein to describe a relationship of one element to another element as illustrated in the figures. It should be understood that relative terms are intended to encompass different orientations of the device in addition to the orientation depicted in the figures. For example, if the device in one of the figures is turned over, elements described as being on the “below” side of other elements would then be oriented on the “above” side of the other elements. Thus, the exemplary term “below” may include both “below” and “above” orientations, depending on the particular orientation of the figure. Similarly, if the device in one of the figures is turned over, elements described as “below” or “beneath” other elements would then be oriented “above” the other elements. Thus, the exemplary terms “below” or “beneath” may include both above and below orientations.

Considering the particular amount of measurement and measurement-related errors discussed (i.e., the limitations of the measurement system), the terminology “about,” “approximately,” “essentially,” or “substantially” used herein includes the average of the stated value and an acceptable range of deviations from the particular value as determined by those skilled in the art. For instance, the terminology “about” may refer to as being within one or more standard deviations of the stated value, or within ±30%, ±20%, ±10%, or ±5%. Furthermore, the terminology “about,” “approximately,” “essentially,” or “substantially” as used herein may be chosen from a range of acceptable deviations or standard deviations depending on the optical properties, etching properties, or other properties, rather than one standard deviation for all properties.

Unless otherwise defined, all terms (including technical and scientific terms) used herein have the same meaning as commonly understood by persons skilled in the art to which the disclosure belongs. It is understood that the terms such as the terms defined in commonly used dictionaries should be interpreted as having meanings consistent with the relevant art and the background or context of the disclosure, and should not be interpreted in an idealized or overly formal manner, unless otherwise defined in the disclosure.

Exemplary embodiments are described herein with reference to cross-sectional views that are schematic views of idealized embodiments. As such, variations from the shapes of the illustrations as a result, for example, of manufacturing techniques and/or tolerances, are to be expected. Thus, embodiments described herein should not be construed as limited to the particular shapes of areas as illustrated herein but are to include deviations in shapes that result, for example, from manufacturing. For example, an area illustrated or described as flat may, typically, have rough and/or nonlinear features. Moreover, sharp angles that are illustrated may be rounded. Thus, the areas illustrated in the figures are schematic in nature and the shapes thereof are not intended to illustrate the precise shape of an area and are not intended to limit the scope of the claims.

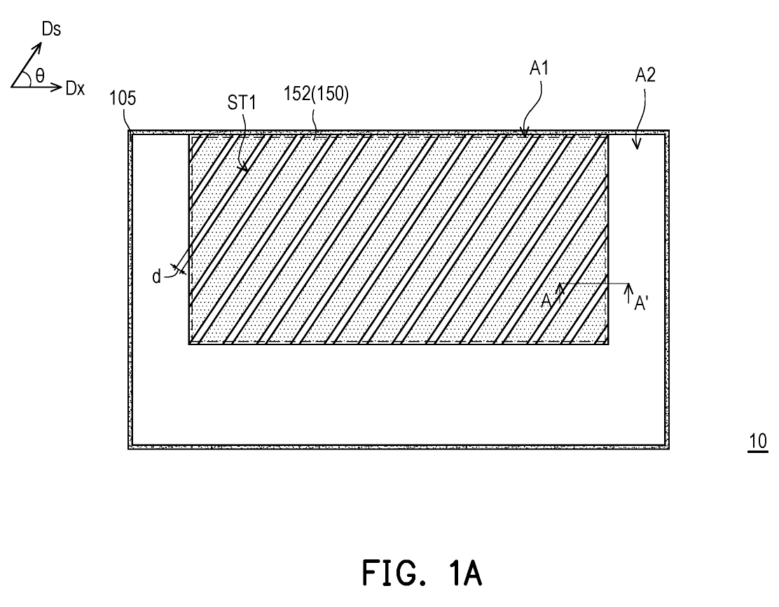

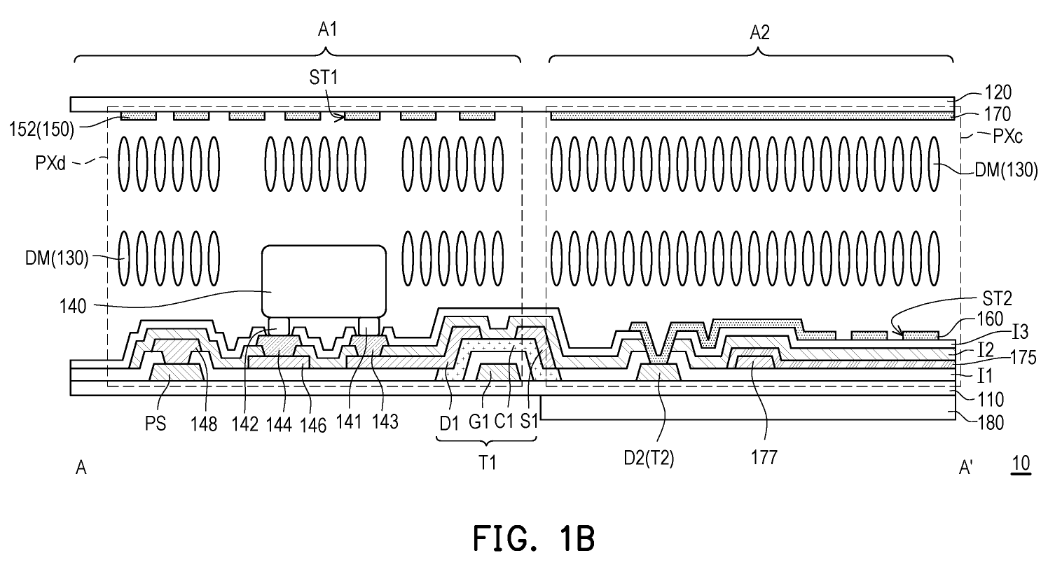

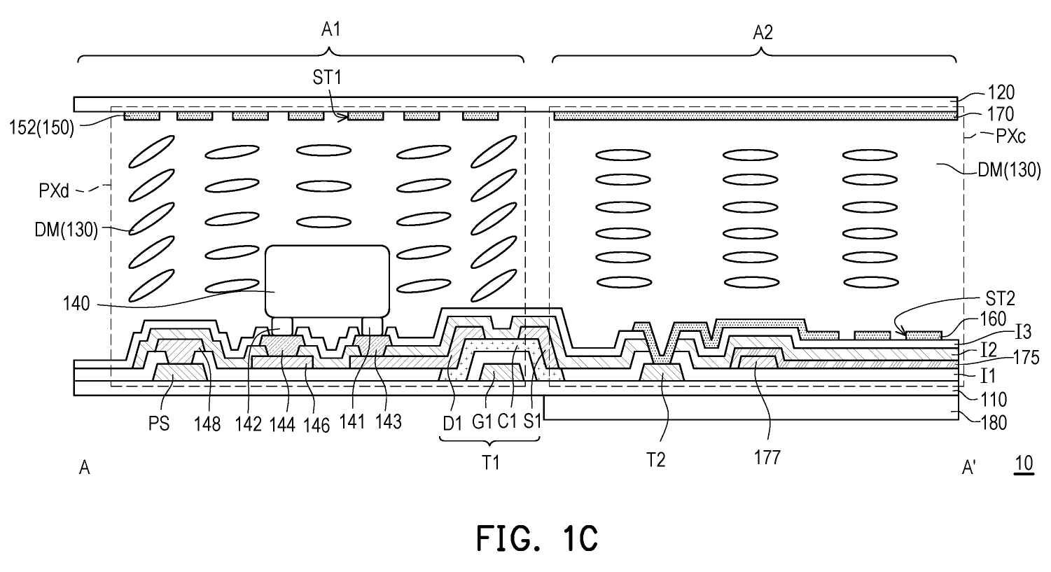

FIG. 1A is a top schematic view of a display device according to an embodiment of the disclosure. FIG. 1B to FIG. 1C are cross-sectional schematic views taken along section line A-A’ of FIG. 1A. For the sake of concise expression in the drawings, FIG. 1A schematically illustrates a display area A1, a display area A2, and a transparent electrode layer 150, while omitting other components.

Referring to FIG. 1A to FIG. 1B, a display device 10 has a display area A1 and a display area A2, and includes a substrate 110, a substrate 120, a display medium layer 130, a light-emitting element 140, a transparent electrode layer 150, and a pixel electrode 160. The substrate 120 overlaps the substrate 110. The display medium layer 130 is located between the substrate 110 and the substrate 120. The light-emitting element 140 is located in the display area A1, and is located between the substrate 110 and the display medium layer 130. The transparent electrode layer 150 is located in the display area A1, located between the substrate 120 and the display medium layer 130, and includes multiple transparent electrode patterns 152 arranged with spacing. The pixel electrode 160 is located in the display area A2, and is located between the substrate 110 and the display medium layer 130 or between the substrate 120 and the display medium layer 130.

In the display device 10 of an embodiment of the disclosure, by disposing the light-emitting element 140 and the transparent electrode layer 150 responsible for 2D/3D switching in an area where 3D display is needed, the thickness and weight of the display device 10 may be reduced, while improving the resolution of 2D display.

In the following, in conjunction with the drawings, the implementation of each element of the display device 10 may continue to be explained, but the disclosure is not limited thereto.

Referring to FIG. 1A, the display device 10 may have the display area A1 and display area A2 adjacent to each other. The display area A2 may be disposed along a side of display area A1. For example, the display area A1 has a rectangular outline, and the display area A2 may be disposed along three sides of the display area A1, so that the display area A2 surrounds the display area A1, but is not limited thereto. In some embodiments, the display area A2 may be disposed along two sides of the display area A1. In other embodiments, the display area A2 may be disposed along four sides of the display area A1, so that the display area A2 surrounds the display area A1. In some embodiments, the display area A1 is a 2D/3D display area, that is, the display area A1 is capable of displaying 2D and 3D images. For example, at some points in time, the display area A1 is capable of displaying 2D images, and at other points in time, the display area A1 is capable of displaying 3D images. Alternatively, during some time periods, the display area A1 is capable of displaying 2D images, and during other time periods, the display area A1 is capable of displaying 3D images.

The display area A2 may only display 2D images. In some embodiments, the 2D images displayed by the display area A2 are presented through a liquid crystal display method. In some embodiments, the 2D images displayed by the display device 10 are presented through the liquid crystal display method in the display area A2 displayed by a self-illuminating element display in the display area A1. Therefore, the resolution of 2D display of the display device 10 may not be affected by a structure of the display area A1 providing 3D display, and may still maintain a resolution similar to, for example, a 2D liquid crystal display device or a 2D light-emitting diode display device.

Referring to FIG. 1B, the substrate 110 of the display device 10 may be a transparent substrate or an opaque substrate, and a material of the substrate 110 may be quartz, glass, polymer (for example, polyimide (PI)), or other suitable materials. The substrate 110 may carry other elements required by the display device 10, such as light-emitting elements, switching elements, and driving elements.

The substrate 120 of the display device 10 may be disposed to face the substrate 110, and the shortest distance between each position on the substrate 120 and the substrate 110 is substantially the same. That is, a substantially uniform spacing may be maintained between the substrate 120 and the substrate 110. Generally, the substrate 120 may be a transparent substrate, and a material of the substrate 120 is, for example, glass, polymer, or other suitable materials. The substrate 110 and the substrate 120 may have the same or different materials. In some embodiments, the substrate 110 and/or the substrate 120 may be a flexible substrate.

The display medium layer 130 is located in the space between the substrate 120 and the substrate 110. For example, the display device 10 further includes a frame glue 105. The frame glue 105 may seal the space between the substrate 110 and the substrate 120 along the edges of the substrate 110 and the substrate 120, so that the display medium layer 130 is enclosed in the space sealed by the substrate 110, the substrate 120, and the frame glue 105, and the display medium layer 130 may be located in the display area A1 and the display area A2. In some embodiments, a material of the frame glue 105 includes at least one of polyurethane acrylate (PUA), epoxy, and silicone, but is not limited thereto.

Display medium molecules DM of the display medium layer 130, for example, include a positive liquid crystal molecule or a negative liquid crystal molecule. In some embodiments, the display medium molecules DM may include vertical alignment (VA) liquid crystal molecules or optically compensated bend (OCB) liquid crystal molecules, to enable the display medium layer 130 in the display area A1 to provide a liquid crystal lens operation mode. In some embodiments, the display medium molecules DM may include VA liquid crystal molecules, OCB liquid crystal molecules, twisted nematic (TN) liquid crystal molecules, or In-Plane Switching (IPS) liquid crystal molecules, to enable the display medium layer 130 in the display area A1 to provide a liquid crystal barrier operation mode.

In the display area A1, the display device 10 may include multiple pixels or sub-pixels PXd. The display area A1 is, for example, an area where the sub-pixels PXd are located. Each sub-pixel PXd may include one or multiple light-emitting elements 140. The light-emitting elements 140 may be disposed on the substrate 110. The light-emitting elements 140 may be, for example, micro light-emitting diodes, organic light-emitting diodes, or other self-illuminating elements. For example, each sub-pixel PXd includes three light-emitting elements, and the three light-emitting elements may have different light colors, for example, red light, green light, and blue light, so that each sub-pixel PXd may constitute a pixel of the display device 10, thereby achieving a full-color display effect. However, there is no special limitation on the quantity or light color of the light-emitting elements 140. In some embodiments, each sub-pixel PXd may include one, two, four, or more light-emitting elements 140.

The display device 10 may further include a circuit structure corresponding to the light-emitting elements 140. The circuit structure includes, for example, a transistor T1. The transistor T1 may be disposed on the substrate 110. For example, the transistor T1 may be disposed between the substrate 110 and the light-emitting element 140. A gate G1 of the transistor T1 may receive a gate signal. A source S1 of the transistor T1 may receive a source signal. By the gate signal controlling the on or off of the transistor T1, the source signal may be transmitted through a channel C1 of the transistor T1 and a drain D1 of the transistor T1 to the electrode 141 of the light-emitting element 140. In some embodiments, the electrode 141 of the light-emitting element 140 is electrically connected to the drain D1 of the transistor T1 through a conductive element 143.

Materials of the gate G1, the source S1, and the drain D1 of the transistor T1 may include opaque conductive materials, for example, molybdenum, aluminum, titanium, copper, gold, silver, other metals, alloys of any two or more of the aforementioned metals, other conductive materials, or a stack of individual layers of two or more of the aforementioned conductive materials. A material of the channel C1 of the transistor T1 may include, for example, polysilicon or conductive oxide, but is not limited thereto.

In some embodiments, the display device 10 further includes a conductive element 144, a conductive wire 146, a conductive wire 148, and a signal source PS. An electrode 142 of the light-emitting element 140 may be electrically connected to the conductive wire 146 through the conductive element 144, the conductive wire 146 may be electrically connected to the conductive wire 148, and the conductive wire 148 may be electrically connected to the signal source PS. By controlling the signal transmitted from the signal source PS or the on or off of the transistor T1, the illumination of the light-emitting element 140 may be controlled. In some embodiments, the signal source PS is a voltage source.

The transparent electrode layer 150 of the display device 10 may be disposed on the substrate 120. For example, the transparent electrode layer 150 may be located between the display medium layer 130 and the substrate 120. The transparent electrode layer 150 may overlap the light-emitting element 140. When no voltage is applied to the transparent electrode layer 150, the display medium molecules DM of the display medium layer 130 may be in a vertically arranged transmissive state, as shown in FIG. 1B. At this time, the display area A1 may present a 2D image provided by the light-emitting element 140. When a voltage is applied to the transparent electrode layer 150, an electric field generated by the transparent electrode layer 150 may drive the display medium molecules DM of the display medium layer 130 to rotate, as shown in FIG. 1C, thereby making some sub-segments in the display area A1 light-transmitting, while other sub-segments are non-light-transmitting, or making the light refraction angles different, to provide an effect similar to a liquid crystal refraction lens or liquid crystal parallax barrier. In this way, the eyes of the viewer are able to respectively receive light from different sub-pixels PXd. That is, both eyes respectively receive different images, thereby generating a 3D visual effect. In some embodiments, the light-transmitting sub-segments and non-light-transmitting segments of the display area A1 may be arranged alternately.

The transparent electrode layer 150 may include multiple transparent electrode patterns 152, for example, strip-shaped transparent electrode patterns. Multiple gaps ST1 may exist between the transparent electrode patterns 152. In some embodiments, the gaps ST1 between the transparent electrode patterns 152 have substantially uniform spacing d. The spacing d may be about 3 μm to 600 μm, for example 100 μm, but is not limited thereto. In some embodiments, the width of the transparent electrode patterns 152 in the same direction as the spacing d is about 3 μm to 600 μm, for example 200 μm, but is not limited thereto. In some embodiments, there is an angle θ between an extension direction Ds of the transparent electrode patterns 152 and a long edge direction Dx of the display device 10. The angle θ may be between 30° and 60°, for example 37° or 55°, but is not limited thereto.

In the display area A2, the display device 10 may include multiple pixels or sub-pixels PXc. The display area A2 is, for example, an area where the sub-pixels PXc are located. In the display area A2, the display device 10 may further include a transistor T2 and a pixel electrode 160 disposed corresponding to the sub-pixel PXc. The pixel electrode 160 is, for example, electrically connected to a drain D2 of the transistor T2. By controlling the on or off state of the transistor T2, a signal may be transmitted to the pixel electrode 160 through the drain D2 of the transistor T2. In some embodiments, the pixel electrode 160 is located between the substrate 110 and the display medium layer 130, but is not limited thereto. In some embodiments, a material of the pixel electrode 160 may include a transparent conductive material. In some embodiments, the drain D2 of the transistors T2 is located between the pixel electrode 160 and the substrate 110. In some embodiments, the pixel electrode 160 has multiple gaps ST2.

In some embodiments, the display device 10 further includes a transparent surface electrode 170. The transparent surface electrode 170 may be located on a side of the display medium layer 130 opposite to the pixel electrodes 160. For example, the transparent surface electrode 170 is disposed on the substrate 120, and the transparent surface electrode 170 is located between the display medium layer 130 and the substrate 120. The transparent surface electrode 170 may be disposed corresponding to the pixel electrode 160. In some embodiments, the transparent surface electrode 170 is only disposed in the display area A2. Through the electric field formed by the pixel electrodes 160 and the transparent surface electrode 170, the display medium molecules DM of the display medium layer 130 located in the display area A2 may be driven to rotate and switch between, for example, a vertical state (as shown in FIG. 1B) and a planar state (as shown in FIG. 1C). In some embodiments, by the magnitude of the applied electric field and the speed of removing the electric field, the state of the display medium molecules DM may be changed.

In other embodiments, the display device 10 further includes a transparent electrode 175 located in the display area A2. The transparent electrode 175 may be disposed on the substrate 110. For example, the transparent electrode 175 is located between the pixel electrode 160 and the substrate 110, and the transparent electrode 175 may receive signals through, for example, a conductive wire 177. In some embodiments, the transparent electrode 175 is a transparent surface electrode. The transparent electrode 175 may be disposed corresponding to the pixel electrode 160. In some embodiments, the transparent electrode 175 is only disposed in the display area A2. Through the electric field formed by the pixel electrodes 160 and the transparent electrode 175, the display medium molecules DM of the display medium layer 130 located in the display area A2 may be driven to rotate and switch between, for example, a vertical state (as shown in FIG. 1B) and a planar state (as shown in FIG. 1C). In some embodiments, by the magnitude of the applied electric field and the speed of removing the electric field, the state of the display medium molecules DM may be changed. In some embodiments, the transparent surface electrode 170 and the transparent electrode 175 may be disposed alternatively.

For example, when all the display medium molecules DM of the sub-pixel PXc are in the vertical state, the display medium layer 130 of the sub-pixel PXc is in a transmissive state. When all the display medium molecules DM of the sub-pixel PXc are in the planar state, the display medium layer 130 of the sub-pixel PXc is in a non-transmissive state. When a part of the display medium molecules DM of the sub-pixel PXc is in the vertical state and another part of the display medium molecules DM is in the planar state, the display medium layer 130 of the sub-pixel PXc is in a partially transmissive state, enabling the display medium layer 130 of the sub-pixel PXc to provide different degrees of transmittance, thereby enabling the sub-pixel PXc to provide, for example, different levels of grayscale. As such, the display medium layer 130 of any sub-pixel PXc in the display area A2 may switch between a non-transmissive state (minimum transmittance), a transmissive state (maximum transmittance), and transmittance between the non-transmissive state and the transmissive state. In some embodiments, the transmittance of the display medium layer 130 is 0% to 95%, for example, about 25%, about 50%, or about 75%.

In some embodiments, the material of the transparent electrode layer 150, the pixel electrode 160, and the transparent surface electrodes 170, 175 each independently includes an oxide of a metal material, a nitride of a metal material, an oxynitride of a metal material, other suitable transparent conductive materials, or a stack of the aforementioned transparent conductive materials, for example, indium tin oxide, indium zinc oxide, aluminum tin oxide, aluminum zinc oxide, indium gallium zinc oxide, or a stack of at least two of the above, but not limited thereto.

In some embodiments, the display device 10 further includes a backlight module 180 located in the display area A2. The backlight module 180 may be disposed corresponding to the sub-pixels PXc in the display area A2 to provide a light source for the sub-pixels PXc.

In some embodiments, the display device 10 further includes insulation layers I1, I2, I3. The insulation layer I1 may be located between the signal source PS and the conductive wire 148. The insulation layer I1 may also be located between the gate G1 and channel C1 of the transistor T1. The insulation layer I1 may also be located between the drain D2 of the transistor T2 and the pixel electrode 160. The insulation layer I1 may also be located between the transparent electrode 175 and the substrate 110. The insulation layer I2 may be located between the drain D1 of the transistor T1 and the conductive element 143. The insulation layer I2 may also be located between the conductive wire 146 and the conductive element 144. The insulation layer I3 may be located between the electrode 141 of the light-emitting element 140 and the conductive element 143. The insulation layer I3 may also be located between the electrode 142 of the light-emitting element 140 and the conductive element 144. The insulation layer I3 may also be located between the pixel electrode 160 and the drain D2 of the transistor T2. A material of the insulation layers I1, I2, I3 may include silicon oxide (SiOx), silicon nitride (SiNx), or other suitable materials. Additionally, the insulation layers I1, I2, I3 in the display area A1 and the insulation layers I1, I2, I3 in the display area A2 may respectively belong to the same film layer.

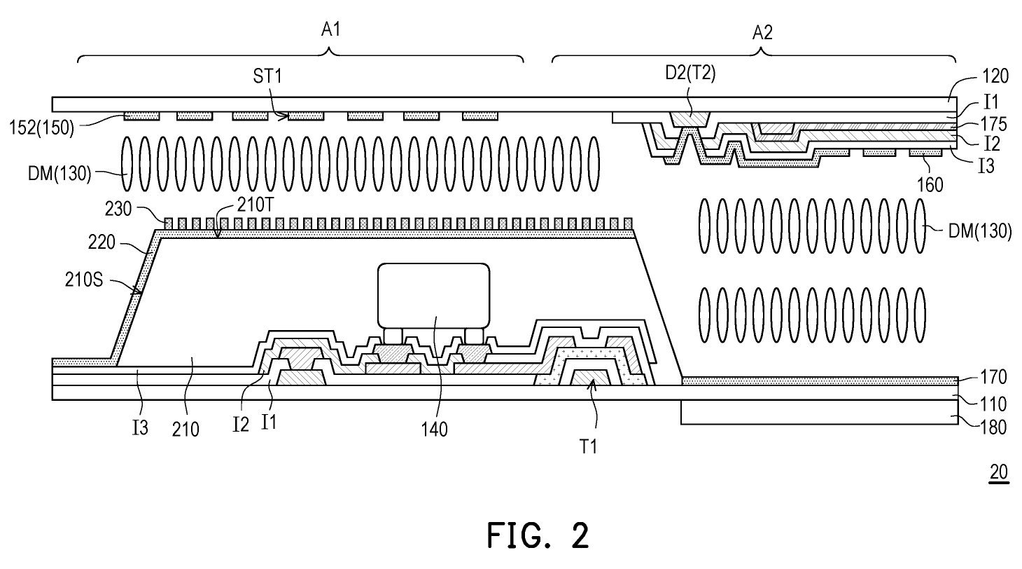

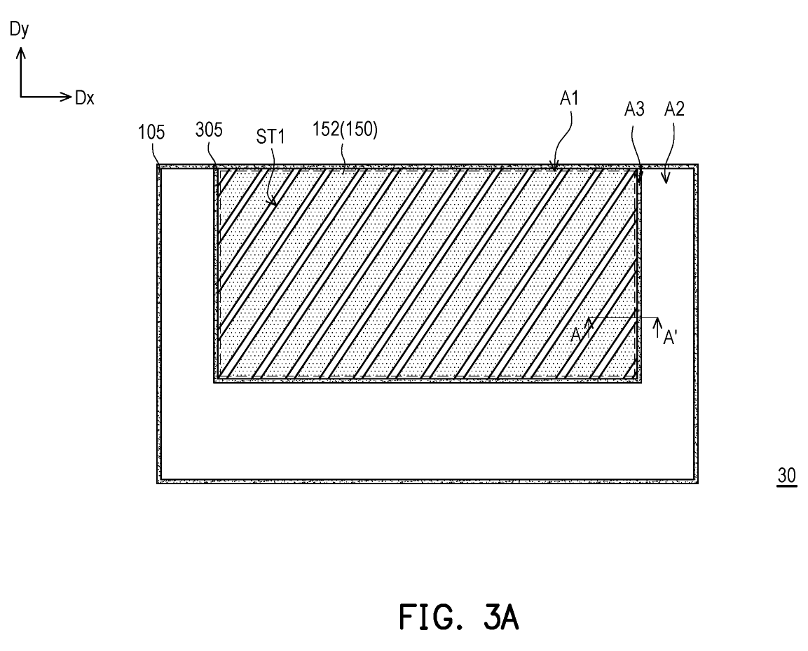

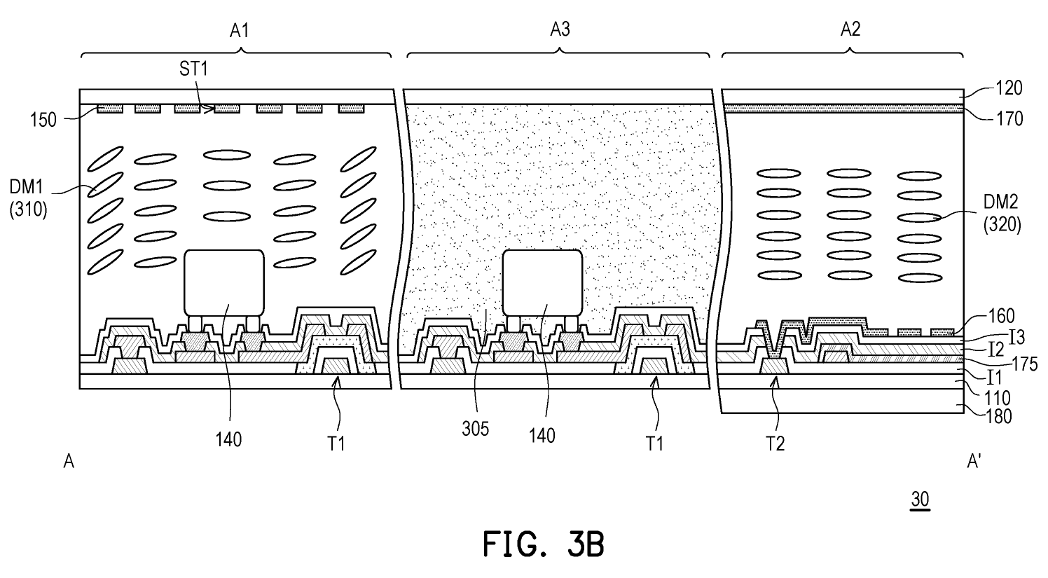

FIG. 2 to FIG. 3B are used to continue describing other embodiments of the disclosure, and the reference numerals of the elements and related content of the embodiments of FIG. 1A to FIG. 1C are reused, where the same reference numerals are used to indicate the same or similar elements, and descriptions of identical technical content are omitted. For descriptions of the omitted parts, reference may be made to the embodiments of FIG. 1A to FIG. 1C, which is not repeated in the following description.

FIG. 2 is a cross-sectional schematic view of a display device according to an embodiment of the disclosure. Referring to FIG. 2, a display device 20 may have a display area A1 and a display area A2. The display device 20 may include a substrate 110, a substrate 120, a display medium layer 130, a light-emitting element 140, a transparent electrode layer 150, a pixel electrode 160, a transparent surface electrode 170, a transparent electrode 175, a backlight module 180, transistors T1, T2, and insulation layers I1, I2, I3.

Compared with the display device 10 shown in FIG. 1B, the main difference in the display device 20 shown in FIG. 2 lies in that: the transparent surface electrode 170 of the display device 20 may be disposed on the substrate 110, and the pixel electrode 160 may be disposed on the substrate 120. For example, the transparent surface electrode 170 is located between the substrate 110 and the display medium layer 130, while the pixel electrode 160 is located between the substrate 120 and the display medium layer 130. In some embodiments, the transparent electrode 175 is located between the pixel electrode 160 and the substrate 120. In some embodiments, the drain D2 of the transistor T2 is located between the pixel electrode 160 and the substrate 120. Additionally, the insulation layers I1, I2, I3 in the display area A1 and the insulation layers I1, I2, I3 in the display area A2 may respectively belong to different film layers.

In addition, the display device 20 may further include a planarization layer 210. The planarization layer 210 is located in the display area A1 and covers the light-emitting element 140 to isolate the light-emitting element 140 from the display medium molecules DM. A material of the planarization layer 210 may include an organic insulation material suitable for Ultra High Aperture (UHA) technology. For example, the planarization layer 210 may include an acrylic material, a siloxane material, a polyimide material, or an epoxy material.

In some embodiments, the display device 20 may further include a transparent surface electrode 220. The transparent surface electrode 220 may be located on the planarization layer 210 in the display area A1, and located on a side of the display medium layer 130 opposite to the transparent electrode layer 150. For example, the planarization layer 210 is located between the transparent surface electrode 220 and the light-emitting element 140. In some embodiments, the transparent surface electrode 220 extends along a side wall 210S and an upper surface 210T of the planarization layer 210. In some embodiments, the transparent surface electrode 220 and the transparent surface electrode 170 in the display area A2 may have the same potential. For example, the transparent surface electrode 220 and the transparent surface electrode 170 may be electrically connected to the same voltage source, but not limited thereto. In other embodiments, the transparent surface electrode 220 and the transparent surface electrode 170 may have different potentials. Through the electric field formed by the transparent surface electrode 220 and the transparent electrode layer 150, the rotation of the display medium molecules DM in the display area A1 may be controlled more precisely, thereby enhancing the 3D display effect of the display area A1.

In some embodiments, the display device 20 further includes a grating 230. The grating 230 may be located on the same side of the display medium layer 130 as the light-emitting element 140, or on the side of the display medium layer 130 opposite to the transparent electrode layer 150. For example, the grating 230 is located between the display medium layer 130 and the transparent surface electrode 220. In some embodiments, the grating 230 is disposed on the upper surface 210T of the transparent surface electrode 220, and may form linearly polarized light from the light emitted by the light-emitting element 140, so that the light passing through the display medium layer 130 has a better polarization pattern, thereby making the presented 3D effect more pronounced. In some embodiments, the display device 20 further includes a multilayer film (not shown in the drawings). The multilayer film is located, for example, on the side of the display medium layer 130 opposite to the grating 230, to reflect light perpendicular to the outgoing light polarization state.

FIG. 3A is a top schematic view of a display device according to an embodiment of the disclosure. FIG. 3B is a cross-sectional schematic view taken along section line A-A’ of FIG. 3A. Referring to FIG. 3A and FIG. 3B, the display device 30 may have a display area A1 and a display area A2, and may include a substrate 110, a substrate 120, a light-emitting element 140, a transparent electrode layer 150, a pixel electrode 160, a transparent surface electrode 170, a transparent electrode 175, a backlight module 180, transistors T1, T2, and insulation layers I1, I2, I3.

Compared with the display device 10 shown in FIG. 1A and FIG. 1B, the main difference of the display device 30 shown in FIG. 3A and FIG. 3B lies in that: the display device 30 may also have a display area A3 located between the display area A1 and the display area A2, and the display device 30 may include a display medium layer 310 located in the display area A1, a display medium layer 320 located in the display area A2, and a frame glue 305 located in the display area A3. In some embodiments, the frame glue 305 isolates the display medium layer 310 from the display medium layer 320, so that the display medium layer 310 and the display medium layer 320 may each select different types of the display medium molecules to optimize the optical performance required by the display area A1 and the display area A2 respectively. In some embodiments, the material of the frame glue 305 may be the same as the material of the frame glue 105, but is not limited thereto.

In some embodiments, the display medium layer 310 includes a first type medium molecule DM1, and the display medium layer 320 includes a second type medium molecule DM2. For example, one of the display medium layer 310 and the display medium layer 320 may use positive liquid crystal, while another of the display medium layer 310 and the display medium layer 320 may use negative liquid crystal. In some embodiments, the birefringence (Δn) of the first type medium molecule DM1 is greater than the birefringence (Δn) of the second type medium molecule DM2. By the birefringence, the display medium molecules (for example, liquid crystal molecules) have optical rotation properties, which may allow light to penetrate and change the direction of light, so that the display area A1 has better 3D display effect.

In addition, compared with the element arrangement of the display area A1, the main difference in the element arrangement of the display area A3 lies in that: the display medium layer 310 and the transparent electrode layer 150 are not disposed in the display area A3. Therefore, the display area A3 may only present a 2D screen. In some embodiments, the display area A3 together with the display area A2 present a 2D screen. In some embodiments, a voltage of the light-emitting element 140 located in the display area A3 is different from a voltage of the light-emitting element 140 located in the display area A1, but is not limited thereto.

The quantity of light-emitting elements 140 covered by the frame glue 305 may depend on the required width of the frame glue 305. In some embodiments, the frame glue 305 covers at least one light-emitting element 140 in the width direction along the long edge direction Dx and the short edge direction Dy of the display device 30. In some embodiments, a part of the light-emitting elements 140 located in the display area A3 is covered by the frame glue 305, and another part of the light-emitting elements 140 located in the display area A3 is not covered by the frame glue 305. For example, some light-emitting elements 140 in the display area A3 adjacent to the display area A1 or the display area A2 may not be covered by the frame glue 305. In some embodiments, the voltage of the light-emitting elements 140 located in the display area A3 covered by the frame glue 305 is different from the voltage of the light-emitting elements 140 overlapping the transparent electrode layer 150 located in the display area A1. In some embodiments, the voltage of the light-emitting elements 140 not overlapping the transparent electrode layer 150 is different from the voltage of the light-emitting elements 140 overlapping the transparent electrode layer 150.

In summary, the display device of the disclosure, by disposing the light-emitting element, the transparent electrode layer, and the display medium layer responsible for 2D/3D switching in the display area requiring 3D display, may reduce the thickness and weight of the display device without affecting the resolution of 2D display. In addition, the display device of the disclosure may also sequentially dispose the UHA planarization layer, the transparent surface electrode, and the grating on the light-emitting element in the 3D display area to further optimize the optical performance of the 3D display area. Furthermore, the display device of the disclosure may also, by disposing the frame glue between the 2D display area and the 3D display area, enable different types of display medium to be disposed in the 2D display area and the 3D display area, to individually optimize the optical performance of each display area.

Although the disclosure has been disclosed in the examples as above, it is not intended to limit the disclosure. Any person skilled in the relevant art, without departing from the spirit and scope of the disclosure, may make some modifications and refinements. Therefore, the scope of protection of the disclosure shall be defined by the appended claims.

What is claimed is:

1. A display device, having a first display area and a second display area, and comprising:
a first substrate;
a second substrate, overlapping the first substrate;
a display medium layer, located between the first substrate and the second substrate;
a light-emitting element, located in the first display area, and located between the first substrate and the display medium layer;
a transparent electrode layer, located in the first display area, and located between the second substrate and the display medium layer, and comprising a plurality of transparent electrode patterns arranged with spacing; and
a pixel electrode, located in the second display area, and located between the first substrate and the display medium layer or between the second substrate and the display medium layer.

2. The display device according to claim 1, wherein a plurality of first gaps exist between the plurality of transparent electrode patterns of the transparent electrode layer.

3. The display device according to claim 1, wherein an angle between an extending direction of the plurality of transparent electrode patterns and a long edge direction of the display device is between 30° and 60°.

4. The display device according to claim 1, wherein the pixel electrode has a plurality of second gaps.

5. The display device according to claim 1, further comprising a planarization layer, the planarization layer being located in the first display area and covering the light-emitting element.

6. The display device according to claim 5, further comprising a first transparent surface electrode, the first transparent surface electrode being located on the planarization layer, and located on a side of the display medium layer opposite to the transparent electrode layer.

7. The display device according to claim 6, further comprising a grating, the grating being located on the first transparent surface electrode, and located on the same side of the display medium layer as the light-emitting element.

8. The display device according to claim 1, further comprising a second transparent surface electrode, the second transparent surface electrode located in the second display area, and located on a side of the display medium layer opposite to the pixel electrode.

9. The display device according to claim 1, further comprising a first frame glue, the first frame glue being located on an edge of the display device.

10. The display device according to claim 1, wherein a number of the light-emitting element is a plurality, the display device further comprises a second frame glue, and the second frame glue covers the light-emitting element adjacent to the second display area among a plurality of light-emitting elements.

11. The display device according to claim 10, wherein the display medium layer comprises:
a first type display medium molecule, located in the first display area; and
a second type display medium molecule, located in the second display area.

12. The display device according to claim 11, wherein a birefringence of the first type display medium molecule is greater than a birefringence of the second type display medium molecule.

13. The display device according to claim 10, wherein a voltage of the light-emitting element covered by the second frame glue is different from a voltage of the light-emitting element overlapping with the transparent electrode layer.

14. The display device according to claim 1, further comprising a first transistor, the first transistor being located in the first display area and electrically connected to the light-emitting element.

15. The display device according to claim 1, further comprising a second transistor, the second transistor being located in the second display area and electrically connected to the pixel electrode.

16. A display device, having a first display area and a second display area adjacent to each other, and comprising:
a first display unit, located in the first display area;
a second display unit, located in the second display area;
a transparent electrode layer, located above the first display unit, and comprising a plurality of transparent electrode patterns arranged with spacing; and
a first display medium layer, located between the transparent electrode layer and the first display unit.

17. The display device according to claim 16, wherein the first display unit comprises a self-illuminating element.

18. The display device according to claim 16, wherein the second display unit comprises a second display medium layer, and a birefringence of a first type display medium molecule of the first display medium layer is greater than a birefringence of a second type display medium molecule of the second display medium layer.

19. The display device according to claim 16, wherein an angle between an extending direction of the plurality of transparent electrode patterns and a long edge direction of the display device is between 30° and 60°.

20. The display device according to claim 16, wherein the spacing between the plurality of transparent electrode patterns of the transparent electrode layer is 3 μm to 600 μm.
